(19) United States
(12) Patent Application Publication
(10) Pub. No.: US 2024/0164384 A1
(43) Pub. Date: May 23, 2024

(54) Antimicrobial Additive Composition

(71) Applicant: Symphony Environmental Ltd., Hertfordshire (GB)

(72) Inventor: Radu Baciu, Hertfordshire (GB)

(73) Assignee: Symphony Environmental Ltd., Hertfordshire (GB)

(21) Appl. No.: 18/551,035

(22) PCT Filed: Mar. 3, 2022
(86) PCT No.: PCT/GB2022/050711

§ 371 Date: Sep. 18, 2023

(30) Foreign Application Priority Data
Mar. 24, 2021 (GB) 2104138.9

(51) Int. Cl. A01N 55/02; A01N 25/08; A01N 59/16; A21D 15/00; B65D 81/28

(52) U.S. Cl. CPC A01N 55/02; A01N 25/08; A01N 59/16; A21D 15/00; B65D 81/28

(57) ABSTRACT

The present invention relates to an additive composition for a polymer substrate comprising a carrier material, an antimicrobial substance present in an amount of from 1% w/w to 50% w/w. and a food preservative present in amount of from 1% w/w to 75% w/w, wherein the antimicrobial substance is different to the food preservative.

The present invention relates to an additive composition having improved antimicrobial properties for a polymer substrate, and in particular to a polymer substrate comprising the additive composition.

In order to obtain an acceptable standard of food quality, maintaining safety and prolonging shelf life of a food product is of paramount importance. Food safety requires meticulous preparation, handling, storing, and packaging of the food product in order to prevent infection, while ensuring that the product maintains sufficient nutrients. A food product must not contain levels of contaminants, such as pathogens or toxins, which cause illness upon consumption, or which cause the organoleptic characteristics of the food product to deteriorate in an unacceptably short period of time. In particular, baked food products must meet consistent standards of safety and shelf life. It is known that food products containing harmful bacteria, viruses, parasites or chemical substances may cause in excess of 200 diseases in humans.

After preparation of a food product, the food product is usually packaged in packaging materials. Packaging materials are prone to contamination by pathogens present in a food processing unit. Packaging is the final step in the production of foods, and thus it is critical for ensuring high quality and prolonged shelf life of the food product. It is known to incorporate additives into plastic packaging materials in order to attempt to increase the shelf life of the packaged product.

Surface bio-contamination is a source of outbreaks of community-acquired and health-associated infection through periodic fomite transmission of disease and/or persistent passive vector reservoirs. The extent to which passive vector reservoirs contribute to the overall extent of infections is unknown, but passive vectors (for example, plastic packaging) are known to play a role in the transmission of many diseases, including SARS. Faster surface die-off of pathogens on a surface can significantly reduce the amount of time that a specific substrate reservoir is capable of transmitting disease and can also reduce the surface population of pathogens available for transmission to a susceptible host.

Effective routine chemical disinfection is difficult because potent chemical solutions must be applied correctly and left in contact with surfaces for prolonged periods of time. Many packaging materials are not amenable to such treatments, and many clinical environments do not accommodate such treatments easily. With respect to food packaging materials, the use of disinfectants or sanitisers to remove contamination from the surfaces is not possible.

Known methods for grinding additive particles include using ball mills, rod mills, autogenous mills, pebble mills, high-pressure grinding mills, tower mills and hammer mills. Once the ground particles are incorporated into the polymer substrate, for example, by extrusion, the particles are visible and poorly dispersed. In addition, the surface/volume ratio of the ground particles is low and thus the efficacy of the particles is poor. Further, processing methods require friction between their components parts which generate heat. Heat adversely affects the physical and chemical properties of the additive, for example, by causing melting, yellowing, burning and/or changes to the crystal structure of the particles. Accordingly, the performance of the additive is compromised.

The terms “additive” and “masterbatch” are used interchangeably throughout this specification.

It is an object of this invention to mitigate problems such as those described above.

According to a first aspect of the invention, there is provided an additive composition for a polymer substrate comprising a carrier material, an antimicrobial substance present in an amount of from 1% w/w to 50% w/w, and a food preservative present in amount of from 1% w/w to 75% w/w, wherein the antimicrobial substance is different to the food preservative.

The invention provides an additive composition for incorporation into a polymer substrate which has improved antimicrobial properties over known additive compositions containing only a single antimicrobial substance.

The additive composition comprises three separate, different ingredients, i.e. i) a carrier material, ii) an antimicrobial substance, and iii) a food preservative. The antimicrobial substance and the food preservative are distinct active agents.

The particular combination of an antimicrobial substance and a food preservative which are different from each other provides a synergistic antimicrobial effect. Polymer products which incorporate the additive composition, such as plastic packaging, act to extend the shelf life of the food product packaged therein, therefore, reducing food waste. Furthermore, the organoleptic characteristics of the packaged food, i.e. colour, odour, texture and taste, are preserved for longer in comparison to known polymer packaging materials.

Typically, food preservatives are added directly to a food product to prevent or inhibit the growth of fungi, bacteria, or microorganisms inside or on the surface of the food product. The use of food preservatives in food products act to reduce or prevent processes such as fermentation, acidification or decomposition due to the activity of microorganisms so that the shelf life of food is extended. With respect to long-life food products, food preservatives act to extend the storage period further, and/or maintain or improve the texture of the food product.

For example, the polymer substrate may be used as packaging for paint. This prevents contamination of the packaged paint and also the surfaces to which the paint is applied. The additive composition is particularly effective when incorporated into a polymer substrate which is used as packaging for foodstuffs. In addition, enhanced antimicrobial activity is achieved using lower concentrations of each of the antimicrobial substance and food preservative individually, than if a single food preservative or antimicrobial substance was used.

The additive composition of the present invention can be incorporated into many different polymer substrates and may be used to package any type of item, i.e. food or non-food products. The inventor has found that the additive composition is easily and effectively incorporated into polyolefins (e.g. polyethylene, polypropylene, copolymers of polyethylene and polypropylene, ethylene-vinyl acetate, thermoplastic elastomers and ionomers), styrenes (e.g. High Impact Polystyrene, General Purpose Polystyrene, acrylonitrile butadiene styrene and styrene acrylonitrile resin), polyesters (e.g. polyethylene terephthalate, polybutylene terephthalate, polylactic acid, polybutylene adipate terephthalate), polycarbonates, polyamides (e.g. Nylon 6 and Nylon 6/6) and polyvinyl chloride.

The carrier material acts as a matrix by encapsulating the antimicrobial substance and the food preservative and effectively disperses these two components. Typically, the carrier material is a carrier resin. Carrier materials which may be used in the present invention include polyethylene, such as linear low-density polyethylene (LLDPE), low-density polyethylene (LDPE), medium-density polyethylene, high-density polyethylene; polypropylene, such as homopolymer polypropylene, random copolymer polypropylene, syndiotactic polypropylene, atactic polypropylene; high impact polystyrene (HIPS); general purpose polystyrene (GPPS); styrene acrylonitrile resin (SAN); polybutylene terephthalate (PBT); polyethylene terephthalate (PET); PolyVinyl Chloride (PVC); Nylon 6 and/or polycarbonate.

Preferably, the additive composition comprises a filler, for example, calcium carbonate or talc. Filler enables the additive to be produced cheaply and improves the physical and chemical properties of the additive.

Further, the additive composition preferably comprises a stabiliser. A heat stabiliser and/or a UV stabiliser may be used. A heat stabiliser provides protection of the additive composition and the polymer substrate into which it is incorporated against oxidation. A UV stabiliser prevents the additive composition and the polymer substrate into which it is incorporated from photo degradation.

Preferably, the antimicrobial substance comprises a pyrithione. A pyrithione is a powerful antimicrobial agent having a wide spectrum efficacy, in particular against Gram-positive and Gram-negative bacteria, fungi, viruses and algae. More preferably, the pyrithione is selected from the group comprising sodium pyrithione, ammonium pyrithione, zinc pyrithione and/or copper pyrithione. Zinc pyrithione and copper pyrithione are particularly advantageous in the additive composition.

Preferably, the antimicrobial substance comprises an isothiazolinone, preferably 4,5-dichloro-2-octyl-2H-isothiazol-3-one. Isothiazolinones are widely used as biocides and easily prepared on an industrial scale. Isothiazolinones are found to be particularly effective against microbes in the additive composition of the present invention.

Preferably, the food preservative is selected from the group comprising sodium nitrite, sodium nitrate, benzoic acid, sodium benzoate, potassium benzoate, sodium metabisulfite, potassium sulfite, sorbic acid, potassium sorbate, propionic acid, sodium propionate, calcium propionate, sulfur dioxide, sodium acetate, sodium butyrate, ethyl paraben, and/or ascorbic acid. The most preferred food preservatives are sodium benzoate, potassium sorbate and sodium nitrite. Such food preservatives are widely available, cheap and are already granted the necessary approval from food regulatory bodies.

Preferably, the antimicrobial substance comprises a silver-zinc zeolite. Preferably, the silver-zinc zeolite is of Type A.

Preferably, the antimicrobial substance is present in an amount from 5% w/w to 25% w/w. Preferably, the food preservative is present in an amount from 50% w/w to 75% w/w. Such quantities of antimicrobial substance and food preservative have been found to provide additive compositions with particularly effective antimicrobial properties.

According to a second aspect of the invention, there is provided a polymer substrate comprising the additive composition as described above. The additive composition imparts antimicrobial properties to the polymer substrate into which it is incorporated. The polymer substrate may be used as packaging for food or non-food products.

Preferably, the polymer substrate is a flexible or rigid plastic packaging. Advantageously, flexible plastic packaging can be used as a film for wrapping and sealing a product, such as a food product. Rigid plastic packaging may be in the form of a tray or box for containing and protecting the packaged product. The plastic packaging may be single use and disposable, or suitable for repeat usage.

Preferably, the flexible or rigid plastic packaging is for a food product, wherein the food product is preferably bread. The additive composition when incorporated into flexible or rigid plastic packaging has been found to be highly effective at protecting and preserving the colour, odour, taste, texture and freshness of the packaged food product. Particularly effective protection of the organoleptic characteristics of bread has been observed.

According to a third aspect of the invention, there is provided a multi-layered polymer substrate for use as packaging, comprising at least an inner layer, an outer layer and a middle layer between the inner layer and the outer layer, wherein the inner layer comprises the additive composition according to the first aspect of the present invention and/or wherein the middle layer comprises the additive composition according to the first aspect of the present invention.

Preferably, the outer layer comprises the additive composition according to the first aspect of the present invention.

Incorporation of the additive composition into an inner layer and/or a middle layer and/or an outer layer of a multilayered polymer substrate which is suitable for use as packaging has been found to effectively prevent contamination of the packaged product, e.g. a food product. Multi-layer films may contain up to 15 layers. The inner layer is the layer which is adjacent the packaged product and the middle layer is positioned between the inner layer and an outer layer. Treatment of the inner layer and/or the middle layer with the additive composition effectively protects the packaged product, e.g. food, by preserving its quality and increasing its shelf life. The outer layer is the layer furthest from the packaged item and provides an external surface which is handled by a user before opening the packaging. Treatment of the outer layer with the additive composition reduces cross contamination between the different parties handling the packaged product, for example in a shop, where packaged food will be handled by a shop worker before it is handled by the end user.

According to a fourth aspect of the invention, there is provided a method of making an additive composition comprising the steps of: (a) jet milling the food preservative present in amount of from 1% w/w to 75% w/w to form food preservative particles; (b) mixing and heating the food preservative particles, a carrier material, and an antimicrobial substance present in an amount of from 1% w/w to 50% w/w to form a homogenous mixture, wherein the antimicrobial substance is different to the food preservative; and (c) processing the homogenous mixture to form at least one pellet of additive composition.

Food preservatives are typically organic, crystalline chemicals. Commercially available food preservative crystals have a typical diameter of from 60 to 250 microns and occasionally greater than 350 microns. Jet milling the food preservative advantageously provides particles which are small enough such that they are invisible to the naked eye and evenly dispersed in the structure of the finished polymer substrate (e.g. plastic packaging). This improves the appearance of the polymer substrate into which the additive is incorporated. Further, the use of jet milling provides food preservative particles having a high surface/volume ratio, resulting in a high efficacy and destructive efficiency, due to a larger surface area of the particles being exposed to microorganisms.

In addition, jet milling micronizes the particles by use of a high speed jet of compressed air or inert gas (e.g. nitrogen to avoid oxidation or any risks of explosion) which causes collisions between particles. The process temperature is low in comparison to other milling techniques, meaning that the physical and chemical characteristics and antimicrobial performance of the food preservative are not adversely affected. Further, there are no moving parts, so the energy consumption and wear on equipment is minimal compared to other known milling methods. The output is a stream of particles having a narrow particle size distribution. Particles leaving the jet mill can be separated (by particle size) using a cyclone, followed by a fluidized bed which dries the particles.

Preferably, the food preservative particles have a diameter of from 1 to 2 microns. This particular range of diameter of food preservative particles provide highly effective antimicrobial activity. Such particles are easily incorporated into a polymer substrate, such as a plastic film.

In use, an additive composition for a polymer substrate according to the present invention is provided. This additive composition can thus be incorporated into a polymer substrate, such as plastic packaging for food items or non-food items.

Additive/Masterbatch Examples 1 to 5 below illustrate preferred additive compositions according to the present invention. Comparative data against Control packaging materials show that when Additive/Masterbatch Examples 1 to 5 are incorporated into polymer substrates, they provide an increased length of time for a) a mould spot to appear on the packaged food product; and b) for mould to completely form on the packaged food product. Thus Additive/Masterbatch Examples 1 to 5 exhibit improved antimicrobial activity compared with inert control packaging materials.

### Additive/Masterbatch Example 1

| Additive Ingredient | Specific Ingredient | % w/w |
|---|---|---|
| Carrier material | LLDPE | 95.5 |
| Antimicrobial substance | Zinc pyrithione | 2 |
| Food preservative | Sodium benzoate | 2.5 |

Additive/Masterbatch Example 1 was incorporated at 1% w/w addition into a single layer packaging material (i.e. a combination of 40% LDPE and 60% LLDPE (thickness 32 microns)).

When used at a 1% w/w addition rate in the single layer packaging material, addition of Additive/Masterbatch Example 1 provides a final film composition of 0.02% zinc pyrithione, 0.025% sodium benzoate, 39.982% LDPE and 59.973% LLDPE.

| | | Days to complete |
|---|---|---|
| | | mould formation |
| | Days to first mould | on packaged |
| | spot on packaged bread | bread (no food |
| Type of Packaging | (no food preservatives) | preservatives) |
| Control 1 | 3 | 6 |
| Single layer combination | 5 | 14 |
| of LDPE and LLDPE | | |
| (thickness 32 microns) | | |
| containing Additive/ | | |
| Masterbatch Example 1 | | |

The control packaging (Control 1) was made from a single layer combination of 40% LDPE and 60% LLDPE (thickness 32 microns). No antimicrobial substance or food preservative was present in Control 1.

### Additive/Masterbatch Example 2

| Additive Ingredient | Specific Ingredient | % w/w |
|---|---|---|
| Carrier material | Polypropylene homopolymer | 40 |
| Antimicrobial substance | Zinc pyrithione | 10 |
| Food preservative | Potassium sorbate | 50 |

Additive/Masterbatch Example 2 was incorporated into an inner layer of a three-layer cast polypropylene homopolymer or polypropylene random copolymer material. The inner layer is the layer immediately adjacent to the packaged food product.

When used at a 1% w/w addition rate in the polypropylene packaging material, addition of Additive/Masterbatch Example 2 provides a final film composition of 0.1% zinc pyrithione, 0.5% potassium sorbate and 99.4% polypropylene (either homopolymer or random copolymer).

| | | Days to complete |
|---|---|---|
| | | mould formation |
| | Days to first mould | on packaged |
| | spot on packaged bread | bread (containing |
| Type of Packaging | (containing preservatives) | preservatives) |
| Control 2 | 6 | 10 |
| Three-layer cast | 13 | 22 |
| polypropylene film | | |
| containing Additive/ | | |
| Masterbatch Example 2 | | |
| in the inner layer | | |

The control packaging (Control 2) was made from a three-layer cast polypropylene (either homopolymer or random copolymer) film. No antimicrobial substance or food preservative was present in Control 2. The packaged bread contained preservatives.

Additive/Masterbatch Example 3

| Additive Ingredient | Specific Ingredient | % w/w |
|---|---|---|
| Carrier material | LLDPE | 30 |
| Antimicrobial substance | Silver-zinc zeolite | 20 |
| Food preservative | Sodium nitrite | 50 |

Additive/Masterbatch Example 3 was incorporated into an inner layer and outer layer of a three-layer combination of 40% LDPE and 60% LLDPE. The inner layer is the layer immediately adjacent to the packaged food product and the outer layer is the layer furthest from the packaged food product.

When Additive/Masterbatch Example 3 is used at a 1% LDR (let down ratio) in the LDPE and LLDPE packaging material, the final film composition is 0.2% silver-zinc zeolite, 0.5% sodium nitrite, 59.58% LLDPE and 39.72% LDPE.

| | | Days to complete |
|---|---|---|
| | Days to first mould | mould formation |
| | spot on packaged | on packaged |
| | bread (containing | bread (containing |
| Type of Packaging | preservatives) | preservatives) |
| Control 3 | 7 | 10 |
| Three-layer combination | 15 | 21 |
| of LDPE and LLDPE | | |
| containing Additive/ | | |
| Masterbatch Example 3 in | | |
| the inner and outer layers | | |

The control packaging (Control 3) was made from a three-layer combination of LDPE and LLDPE. No antimicrobial substance or food preservative was present in Control 3.

For the three-layer combination of LDPE and LLDPE containing Additive/Masterbatch Example 3 in the inner and outer layers, the following results were also obtained:

| Standard | Result |
|---|---|
| ISO 22196 against Gram (+) | Greater than 99.999% bacterial destruction |
| and Gram (−) bacteria | |
| ASTM E-2180 against fungi | Greater than 99.99% fungal destruction |
| ASTM D-5589 against algae | Greater than 99.65% |
| ISO 21702-2019 against | Greater than 99.999% (24 hours) |
| coronaviruses | |

### Additive/Masterbatch Example 4

| Additive Ingredient | Specific Ingredient | % w/w |
|---|---|---|
| Carrier material | Polyproylene random copolymer | 30 |
| Antimicrobial substance | Copper pyrithione | 20 |
| Food preservative | Sodium benzoate | 50 |

Additive/Masterbatch Example 4 was incorporated into an inner layer of a three-layer combination of blown random co-polymer polypropylene film (thickness 32 microns). The inner layer is the layer immediately adjacent to the packaged food product.

When Additive/Masterbatch Example 4 is used at a 1% LDR in the polypropylene random copolymer packaging material, the final film composition is 0.2% copper pyrithione, 0.5% sodium benzoate and 99.3% polypropylene random copolymer.

| | | Days to complete |
|---|---|---|
| | Days to first mould | mould formation on |
| | spot on packaged | packaged brie |
| Type of Packaging | brie cheese | cheese |
| Control 4 | 6 | 11 |
| Three-layer combination | 14 | 21 |
| of blown random co-polymer | | |
| polypropylene film | | |
| (thickness 32 microns) | | |
| containing Additive | | |
| Example 4 in the inner layer | | |

The control packaging (Control 4) was made from a three-layer combination of blown random co-polymer polypropylene film (thickness 32 microns). No antimicrobial substance or food preservative was present in Control 4

### Additive/Masterbatch Example 5

A combination of three different masterbatches (A to C, as set out below) were used in Example 5.

Masterbatch A:

| Additive Ingredient | Specific Ingredient | % w/w |
|---|---|---|
| Carrier material | LLDPE | 75 |
| Antimicrobial substance | Zinc pyrithione | 25 |

Masterbatch B:

| Additive Ingredient | Specific Ingredient | % w/w |
|---|---|---|
| Carrier material | LLDPE | 25 |
| Food preservative | Sodium benzoate | 75 |

Masterbatch C:

| Additive Ingredient | Specific Ingredient | % w/w |
|---|---|---|
| Carrier material | LLDPE | 25 |
| Food preservative | Potassium sorbate | 75 |

Additive/Masterbatch Example 5 (including Masterbatches A, B and C) was incorporated into an inner layer and an outer layer of a three-layer combination of 40% LDPE and 60% LLDPE (thickness 36 microns). The inner layer is the layer immediately adjacent to the packaged food product and the outer layer is the layer furthest from the packaged food product.

Masterbatch A was used at 1% addition rate and Masterbatches B and C were both used at 5% LDR in the LDPE and LLDPE packaging material. The final film composition was 0.25% zinc pyrithione, 3.75% sodium benzoate, 3.75% potassium sorbate, 55.35% LLDPE and 36.9% LDPE.

| | Days to first mould | Days to complete |
|---|---|---|
| | spot on packaged | mould formation on |
| Type of Packaging | feta cheese | packaged feta cheese |
| Control 5 | 9 | 13 |
| Three-layer combination | 20 | 27 |
| of LDPE and LLDPE | | |
| (thickness 36 microns) | | |
| containing Additive/ | | |
| Masterbatch Example | | |
| 5 in the inner and | | |
| outer layers | | |

The control packaging (Control 5) was made from 40% LDPE and 60% LLDPE. No antimicrobial substance or food preservative was present in Control 5.

For the three-layer combination of 40% LDPE and 60% LLDPE containing Additive/Masterbatch Example 5 in the inner and outer layers, the following results were also obtained:

| Standard | Result |
|---|---|
| ISO 22196 against Gram (+) | Greater than 99.999% bacterial destruction |
| and Gram (−) bacteria | |
| ASTM E-2180 against fungi | Greater than 99.99% fungal destruction |
| ASTM D-5589 against algae | Greater than 99.65% |
| ISO 21702-2019 against | Greater than 99.999% (24 hours) |
| coronaviruses | |

TABLE A
Bread in control packaging

| | 25° C. 80% R.H.-Light | | | | 35° C. 80% R.H.-Light | | | | 45° C. 80% R.H.-Light | | |
|---|---|---|---|---|---|---|---|---|---|---|---|
| Days | Aw | % Hum | pH | Hardness | Aw | % Hum | pH | Hardness | Aw | % Hum | pH |
| Day 0 | 0.9170 | 35.38 | 5.47 | 278.527 | 0.9170 | 35.38 | 5.47 | 278.527 | 0.9170 | 35.38 | 5.47 |
| Day 3 | | | | | | | | | 0.7980 | 30.81 | 4.9 |
| Day 6 | | | | | 0.8708 | 33.62 | 5.31 | 390.275 | 0.7672 | 29.62 | 3.8 |
| Day 12 | 0.8786 | 33.92 | 5.28 | 315.827 | 0.8254 | 31.87 | 4.87 | 615.922 | | | |
| Day 32 | 0.8403 | 32.44 | 4.30 | 451.742 | | | | | | | |

TABLE B
Bread in packaging containing an additive

| | 25° C. 80% R.H.-Light | | | | 35° C. 80% R.H.-Light | | | | 45° C. 80% R.H.-Light | | | |
|---|---|---|---|---|---|---|---|---|---|---|---|---|
| Days | Aw | % Hum | pH | Hardness | Aw | % Hum | pH | Hardness | Aw | % Hum | pH | Hardness |
| Day 0 | 0.9170 | 35.38 | 5.47 | 278.527 | 0.9170 | 35.38 | 5.47 | 278.527 | 0.9170 | 35.38 | 5.47 | 278.527 |
| Day 2 | | | | | | | | | | | | 308.941 |
| Day 4 | | | | | | | | 368.251 | | | | 381.780 |
| Day 6 | | | | 286.820 | | | | | 0.7791 | 30.08 | 5.25 | 403.682 |
| Day 8 | | | | | | | | 384.816 | | | | 423.781 |
| Day 10 | | | | | | | | | | | | 502.790 |
| Day 12 | | | | 300.528 | 0.8359 | 32.27 | 5.39 | 398.382 | 0.6235 | 24.07 | 4.2 | 663.826 |
| Day 16 | | | | | | | | 429.460 | | | | |
| Day 18 | 0.8672 | 33.48 | 5.33 | 316.385 | | | | | | | | |
| Day 20 | | | | | | | | 482.771 | | | | |
| Day 24 | | | | 347.842 | 0.7638 | 29.49 | 5.07 | 577.442 | | | | |
| Day 30 | | | | 376.284 | | | | | | | | |
| Day 36 | 0.8452 | 32.63 | 4.8 | 401.035 | | | | | | | | |

### Abbreviations

Aw: Water activity p1 % Hum: % Humidity

The control packaging referred to in Table A includes 60% LLDPE and 40% LDPE and does not contain an additive/masterbatch according to the present invention.

With reference to Table B, the packaging contains an additive or masterbatch according to the present invention, comprising 10% w/w of zinc pyrithione as an antimicrobial substance, 40% w/w of potassium sorbate as a food preservative and 50% LLDPE as a carrier material. When this additive is incorporated into a 40% LDPE and 60% LLDPE packaging material at 1% LDR, the resulting film has the composition: 0.1% w/w of zinc pyrithione, 0.5% w/w potassium sorbate, 59.64% w/w LLDPE and 39.76% w/w LDPE.

The above test results show that the polymer packaging containing an additive composition according to the present invention creates an enclosed atmosphere or environment having a basic pH, in which the packaged food item resides. The basic pH caused by the antimicrobial substance and food preservative has the effect of killing microorganism, such as bacteria. Further, the results show that the texture of the bread is maintained for longer when packaged in the antimicrobial packaging in comparison to when the bread is packaged in the control packaging. In other words, it takes longer for the bread to harden when packaged the antimicrobial packaging.

With respect to the humidity levels inside of the packaging, the moisture/humidity loss in the packaging containing an additive composition according to the present invention is slower than in the control packaging at the same temperature and during the same time period. This is despite polyethylene and polypropylene alone exhibiting relatively poor Moisture Vapour Transmission Rate performance in comparison to other known polymers. Therefore, the antimicrobial substance acts to retain water inside the packaging system. This in turn provides protection against drying of the packaged bread which would cause the bread to harden (compromising the texture). Thus, the additive composition of the present invention when incorporated into a polymer substrate prevents degradation of the texture of the packaged food, which increases the shelf life of the food and reduces waste.

The packaging containing an additive composition according to the present invention is extremely efficient against bacteria, fungi, yeasts, algae and viruses. There is good efficacy against prokaryotes (e.g. bacteria), in which the additive composition acts to disrupt the plasma membrane function by interfering with phospholipids, cause metal ion chelation and interference with trans-membrane transport. In eukaryotes (e.g. fungi, yeasts and algae), good efficacy is also observed. In eukaryotes, the additive composition acts to disrupt the membrane function, cause interference with iron metabolism and deactivates mitochondrial Fe-S loading proteins.

In addition, for the polymer packaging containing an additive composition according to the present invention (i.e. 10% w/w of zinc pyrithione as an antimicrobial substance, 40% w/w of potassium sorbate as a food preservative and 50% LLDPE as a carrier material):
The killing rate of bacteria in 2 minutes is greater than 96% (tested as per ASTM D-7907, early kill rate);
The killing rate against Gram (+) and Gram (−) bacteria as per ISO 22196 is minimum 99.999%;
· The killing rate against fungi, as per ASTM E-2180 is minimum 99.99%; and
The killing rate against beta coronavirus, as per ISO 21702-2019, is 99.9% at 1 hour, 99.99% at 2 hours, and 99.999% at 24 hours.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. An additive composition for a polymer substrate comprising
a carrier material,
an antimicrobial substance present in an amount of from 1% w/w to 50% w/w, and
a food preservative present in amount of from 1% w/w to 75% w/w,
wherein the antimicrobial substance is different to the food preservative.

17. The additive composition according to claim 16, wherein the antimicrobial substance comprises a pyrithione.

18. The additive composition according to claim 17, wherein the pyrithione is selected from the group comprising sodium pyrithione, ammonium pyrithione, zinc pyrithione and/or copper pyrithione.

19. The additive composition according to claim 16, wherein the antimicrobial substance comprises an isothiazolinone, preferably 4,5-dichloro-2-octyl-2H-isothiazol-3-one.

20. The additive composition according to claim 16, wherein the antimicrobial substance comprises a silver-zinc zeolite.

21. The additive composition according to claim 16, wherein the food preservative is selected from the group comprising sodium nitrite, sodium nitrate, benzoic acid, sodium benzoate, potassium benzoate, sodium metabisulfite, potassium sulfite, sorbic acid, potassium sorbate, propionic acid, sodium propionate, calcium propionate, sulfur dioxide, sodium acetate, sodium butyrate, ethyl paraben, and/or ascorbic acid.

22. The additive composition according to claim 16, wherein the antimicrobial substance is present in an amount of from 5% w/w to 25% w/w.

23. The additive composition according to claim 16, wherein the food preservative is present in an amount of from 50% w/w to 75% w/w.

24. A polymer substrate comprising the additive composition of claim 16.

25. A polymer substrate according to claim 24, wherein the polymer substrate is a flexible or rigid plastic packaging.

26. A polymer substrate according to claim 25, wherein the flexible or rigid plastic packaging is for a food product, wherein the food product is preferably bread.

27. A multi-layered polymer substrate for use as packaging, comprising at least an inner layer, an outer layer and a middle layer between the inner layer and the outer layer, wherein the inner layer comprises the additive composition according to claim 16, and/or wherein the middle layer comprises the additive composition according to claim 16.

28. A multi-layered polymer substrate according to claim 27, wherein the outer layer comprises the additive composition.

29. A method of making an additive composition according to claim 16 comprising the steps of:
(a) jet milling a food preservative present in amount of from 1% w/w to 75% w/w to form food preservative particles;
(b) mixing and heating the food preservative particles, a carrier material, and an antimicrobial substance present in an amount of from 1% w/w to 50% w/w to form a homogenous mixture, wherein the antimicrobial substance is different to the food preservative; and
(c) processing the homogenous mixture to form at least one pellet of additive composition.

30. A method of making an additive composition according to claim 29, wherein the food preservative particles have a diameter of from 1 to 2 microns.
